(19) United States
(12) Patent Application Publication
(10) Pub. No.: US 2007/0077398 A1
(43) Pub. Date: Apr. 5, 2007

(54) Plastically deformable mat

(75) Inventors: Eduardo Aguilera, Manchester, TN (US); Von Moody, Manchester, TN (US)

Correspondence Address: JACKSON, DEMARCO, TIDUS & PACKENPAUGH, 2815 TOWNSGATE ROAD, SUITE 200, WESTLAKE VILLAGE, CA, 91361-3010, US

(73) Assignee: VIAM Manufacturing, Inc.

(21) Appl. No.: 11/243,861

(22) Filed: Oct. 4, 2005

(51) Int. Cl. B32B 1/00

(52) U.S. Cl. 428/174; 428/364; 428/192

(57) ABSTRACT

Disclosed is a plastically deformable mat formed of a conformable sheet-form body and a plastically deformable member secured to the conformable sheet-form body. The conformable sheet-form body can have a predetermined surface area to cover a specified portion of an underlying contoured surface and the plastically deformable member can be positioned in the mat, so that the plastically deformable member overlies at least a portion of the contour when the mat covers the underlying surface.

### BACKGROUND OF THE INVENTION

1. Field of the Invention

The present invention relates to the mechanical arts. In particular, the present invention relates to a mat that is conformable to the shape of an adjacent surface.

2. Description of Related Art

Mats have a variety of uses, including uses as floor coverings. A mat's function may be to protect an underlying floor, to decorate, to provide anti-skid/anti-slip properties, to insulate, to comfort, or to provide some combination of these and other functions.

Mats may be constructed from rigid, semi-rigid, or pliable materials. The use of the mat will frequently determine which material is most appropriate. As an example, an entryway mat for cleaning muddy shoes might be made from a rigid or semi-rigid plastic. In contrast, a foldable bath mat would likely be made from a pliable fabric suited for that use.

Consumers today can choose from many different mats that fit into the rigid, semi-rigid, or pliable categories. However, these mats are not well suited for applications requiring a conformable mat that resists distortion after it is conformed to an adjacent surface.

In particular, floor mats of many diverse designs have been developed for the passenger compartments of vehicles. These floor mats have been produced in various styles, including pairs of mats wherein separate mats are provided at each of the respective sides of the passenger compartment. When designed for the front seat areas, the mats have a basic dimensional configuration such that they not only cover the substantially planar area in front of a seat, but are of a length to extend forwardly over the lower portion of the fire wall or engine compartment wall which is usually upwardly inclined in a forward direction. Furthermore, in some designs, for both front and rear seat areas, the width of the mat is such that the mat extends up over a central tunnel, up over a side sill or up over both.

A difficulty with such floor mats is that they have a strong tendency to shift and move laterally over the surface of the vehicle. Such lateral shifting movement results from the sliding movement of a person's feet when positioned on a mat or the development of laterally directed forces applied to a carpet through a person's feet while entering or exiting the vehicle. This is highly undesirable, in that the mat not only loses its neat looking appearance but additionally, it frequently will shift into a position where it does not protect the floor and, in the case of the driver's station, can easily interfere with the operation and control of the vehicle. Consequently, it is particularly important to design the floor mats so that they will tend to stay in a desired and selected position in the vehicles.

One approach at overcoming this difficulty is taught in U.S. Pat. Nos. 4,399,176 and 4,465,720 to Bell et al. They describe floor mats that include rigid ribs positioned in the mats, so that when the mat is placed in a vehicle, the ribs are adjacent to the planar area in front of the seat. However, it is a drawback of such a design that where the ribs are adjacent to an irregular surface, they do not allow the mat to conform to that surface. Ribs could not therefore be positioned in portions of the mat transitioning from the floorboard to the console, sill or firewall areas.

Accordingly, there has existed a definite need for a floor mat that effectively conforms to the contours of the underlying surface. There has existed a further need for a floor mat, especially a vehicular floor mat, which does not slide once placed on the floor. The present invention satisfies these and other needs, and provides further related advantages.

### SUMMARY OF THE INVENTION

Now in accordance with the invention, there has been found a plastically deformable mat that effectively conforms to the contour of an underlying contoured surface and that resists sliding once placed on the contoured surface. The mat includes a conformable sheet-form body and a plastically deformable member secured to the conformable sheet-form body, for example, by securing the plastically deformable member to the edge of the conformable sheet-form body or by embedding the plastically deformable member in the conformable sheet-form body.

Plastically deformable members may be made from steel, copper, copper alloys, plastic, and other plastically deformable materials. Preferred plastically deformable members are formed of metal and, in particular, formed of steel having a carbon content of less than about 0.5%. And in some embodiments, the conformable sheet-form body has a predetermined surface area to cover a specified portion of an underlying contoured surface and the plastically deformable member is positioned in the mat, so that the plastically deformable member overlies at least a portion of the contour when the mat covers the underlying surface.

The conformable sheet-form body is formed of any suitable material, such as a fabric material, a heat-curable elastomeric material or a heat-curable thermoplastic material. In one embodiment, the conformable sheet-form body contains multiple layers with a top layer made of a fabric material and a bottom layer made of a heat-curable elastomeric material or a heat-curable thermoplastic material.

The plastically deformable member is of any suitable shape and dimensions. Representative members have configurations that are sheet-like, are rod- or wire-like or that are configured as a flat strip. A preferred plastically deformable member is made of steel wire.

### BRIEF DESCRIPTION OF THE DRAWINGS

The present invention is described with reference to the accompanying figures. In the figures, like reference numbers indicate identical or functionally similar elements. The accompanying figures, which are incorporated herein and form part of the specification, illustrate the present invention and, together with the description, further serve to explain the principles of the invention and to enable a person skilled in the relevant art to make and use the invention.

FIG. 1 is a perspective view of a first embodiment of a conformable mat in accordance with the present invention.

FIG. 2 is a perspective view of a second embodiment of a conformable mat in accordance with the present invention.

FIG. 3 is an enlarged cut-away view of a portion of the mat shown in FIG. 2.

### DESCRIPTION OF THE PREFERRED EMBODIMENTS

Particular embodiments of the invention are described below in considerable detail for the purpose of illustrating its principles and operation. However, various modifications may be made, and the scope of the invention is not limited to the exemplary embodiments described below. For example, while specific reference is made to floor mats to be used in a vehicle's passenger compartment, it can be appreciated that the invention is of equal utility for mats used to cover other contoured surfaces.

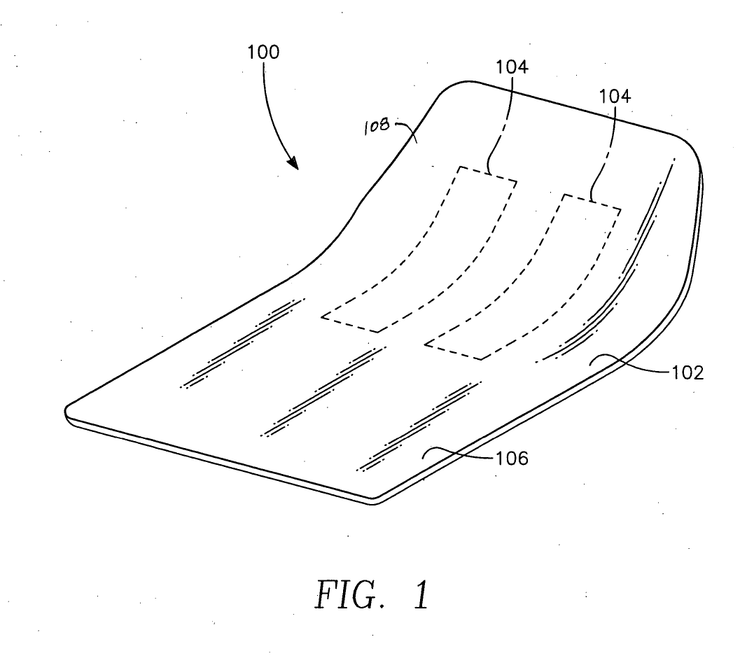

FIG. 1 shows a plastically deformable mat 100 in accordance with the present invention. The mat includes a relatively thin, conformable, sheet-form body 102 and one or more plastically deformable members 104, formed with or otherwise secured to the body.

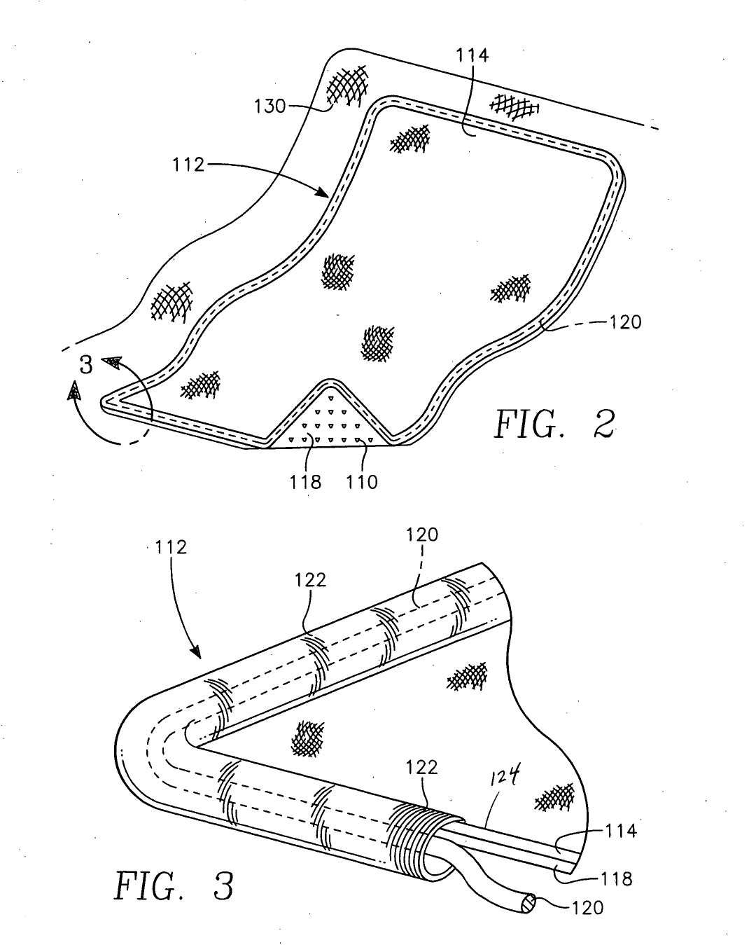

The conformable body 102 has a predetermined surface area to cover a specified portion of an underlying contoured surface 130 (as shown in FIG. 2). In the embodiment shown in FIG. 1, the conformable body is shaped to fit in the passenger compartment of an automobile. The conformable body has a first portion 106 designed to overlay the flat, horizontal floor area on one side of the passenger compartment and a second portion 108 formed at the front for extending a distance upwardly over the upwardly and forwardly inclined engine compartment wall. The conformable body 102 may be made from any suitable flexible material or combination of materials. For example, the conformable body may be formed of a fabric material such as a carpet material which is wear-resistant and has a pleasing appearance. The carpet material may be tufted, woven, needle punched or the like, and may be backed or unbacked. The carpet material may be of a looped pile carpet or a tufted pile carpet construction, i.e., a plurality of pile yarns extend through a primary backing to form loops which are, in the case of a tufted pile carpet, cut to form tufts. The fibers of the pile yarns can be composed of natural or synthetic fibers and may be thermoplastic or thermosetting. Suitable carpet fibers include polyamide fibers such as nylon fibers, particularly nylon 6 and nylon 66, polyester fibers, acrylic fibers, polypropylene and blends and copolymers thereof. In other embodiments, the fabric is a woven or knit fabric, non-woven carpet or the like.

Alternatively, the conformable body 102 may be formed of a heat-curable elastomeric material or a thermoplastic material. Suitable elastomeric materials include rubbers such as natural rubber, butadiene polymers and copolymers such as styrene-butadiene rubbers and polybutadiene rubbers, isoprene polymers and copolymers, chloroprene rubbers such as neoprene, nitrile rubbers, butyl rubbers, and ethylene-propylene rubbers, and blends and copolymers thereof. Styrene-butadiene rubbers are particularly preferred for use in the present invention. Suitable thermoplastic materials include polyvinyl chloride, polyethylene, ethylene vinyl acetate, polypropylene, polystyrene, thermoplastic rubber, thermoplastic olefins, and styrene butadiene block copolymers.

It is an advantage of the heat-curable elastomeric material or thermoplastic materials that they can be provided with a multiplicity of relatively short, conically-shaped projections or nibs 110 (as shown in FIG. 3) that are formed on the lower surface. Such nibs help prevent lateral movement when the floor mat is placed over a carpeted surface.

The conformable body 102 may be formed of a single layer, as shown in FIG. 1, or more than one layer, as shown in FIG. 2. When formed of more than one layer, the layers may be made of the same or of different materials.

The plastically deformable member 104 may have any shape and dimension, such that when deformed to conform to the shape of an underlying surface 130, the mat 100 is caused to conform to and retain the shape of the surface. For example, in the embodiment in FIG. 1, two plastically deformable members each have a sheet-like configuration. Alternatively, one or more plastically deformable members that are flat strips or rod-like elements having, for example, circular, square or rectangular cross sections, can be employed. The plastically deformable member is positioned in the mat, so that it overlies at least a portion of a contour of the underlying surface when the mat is placed over the surface. For example, in the embodiment shown in FIG. 1, the plastically deformable member is positioned so that when the mat is placed in the passenger compartment, the plastically deformable member will overlie that portion of the passenger car that transitions from the floor to the firewall.

The plastically deformable member 104 is made from any suitable plastically deformable material, i.e., deformation of the deformable member caused by an applied stress remains after the stress is removed. Representative plastically deformable materials include ductile metals such as low and medium carbon steels, copper and copper alloys, plastics, and the like. In a preferred embodiment, the deformable member is made from steel having a carbon content of less than about 0.5%. Where the deformable member is made by rolling or drawing a metal, it may be annealed thereafter to obtain the desired ductility.

The plastically deformable member 104 is formed with or secured in fixed relationship to the conformable body 102, by any suitable method. In the embodiment shown in FIG. 1, the plastically deformable members are a pair of steel sheets 104 embedded in a styrene-butadiene rubber conformable body. A plastically deformable member which is thus embedded in the mass of an elastomeric or thermoplastic body, such as by a molding operation, will be fixed firmly in the surrounding mass of the body.

In some embodiments, the conformable body 102 may be formed with a substantially closed recess or channel having a cross-sectional shape and a configuration in plan view to conform with and receive a specifically shaped plastically deformable member. The plastically deformable member 104 may be inserted in the channel where it is mechanically retained in securely fixed relationship, with insertion being facilitated through the flexibility of the material from which the body is fabricated.

In other embodiments, the plastically deformable member 104 may be adhesively secured, taped, or otherwise fixed to the surface of the body 102. And in some embodiments, especially in those embodiments where the conformable body is made of fabric, the plastically deformable member may be secured to the body by direct sewing or stitching. Combinations of these methods may also be employed.

A preferred embodiment of a mat 112 in accordance with the invention is illustrated in FIGS. 2 and 3. In this embodiment, the conformable body 102 is formed of a multilayer material comprising a fabric, such as a nylon carpet, top layer 114 and an elastomeric material or thermoplastic material, such as styrene-butadiene rubber, bottom layer 118 bounded by an edge 122. Such conformable bodies are known in the art and can be formed, for example by adhering the first layer to the second layer using an adhesive, such as a hot melt or pressure sensitive adhesive, or double-sided tape. In some embodiments, the first layer may be sewn, stitched or riveted to the second layer. In other embodiments, the body can be formed by a compression molding process in which the elastomeric material or thermoplastic material flows through the woven textile fabric and thereby embeds the first layer integrally into the second layer.

In the embodiment shown in FIGS. 2 and 3, a steel wire 120 is secured to the edge 124 using yarn 122 and stitching. The steel wire is coextensive with both the length and the width of the conformably body 102. Consequently, it is positioned so that when the mat 112 is placed in the passenger compartment of a vehicle, the wire will overlie that portion of the passenger compartment that transitions from the floor to the firewall.

Where the wire 120 is secured with yarn 122, portions of it may become exposed or otherwise visible during use of the mat 112. Because of this, it is preferable that a coating matching the color of the yarn be applied to the wire to preserve a neat appearance. Typical coating materials include enamel, epoxy, and polymers such as polyvinyl chloride, polyester, and polyethylene. These coatings may be applied by painting, powder coating, or extrusion. A polymeric paint is preferred for use in the present invention.

In operation, the mat is sized to be coextensive with at least a portion of an underlying contoured surface, such as the surface of the passenger compartment of a vehicle. Installation of the mat includes the steps of placing the mat on the underlying surface and conforming the mat to the shape of the underlying surface by using pressure, such as the pressure that can be directly exerted by hand, to deform both the conformable body and the plastically deformable member, so that the mat conforms to the contours of the underlying surface. Such direct pressure will exceed the plastic deformation limit of the plastically deformable member. Consequently, after installation, the plastically deformable member will retain its deformed shape, thus causing the shape of the entire mat to conform to the shape of the underlying surface.

It is an advantage of the invention that typical, subsequent external forces such as those that tend to make the mat slide are resisted by the conformation of the mat 100, 112 to the contours of the adjacent surface 130. Here, the external forces do not cause stress in the plastically deformed members 104, 120 that exceeds the members' plastic deformation limit. Therefore, the plastically deformed members and, in turn, the mat, retain their shape.

While various embodiments of the present invention have been described above, it should be understood that they have been presented by way of example only, and not limitation. It will be understood by those skilled in the art that various changes in form and details can be made therein without departing from the spirit and scope of the invention as defined in the appended claims. Thus, the breadth and scope of the present invention should not be limited by any of the above-described exemplary embodiments, but should be defined only in accordance with the following claims and their equivalents.

What is claimed is:

1. A plastically deformable mat for conforming to the contour of an underlying contoured surface comprising:
a conformable sheet-form body bounded by an edge and having a predetermined surface area to cover a specified portion of an underlying contoured surface; and
a plastically deformable member secured to the conformable sheet-form body, the plastically deformable member positioned in the mat so that the plastically deformable member overlies the contour when the mat covers the underlying surface.

2. The mat of claim 1 wherein the plastically deformable member is deformable in response to hand-applied pressure.

3. The mat of claim 1 wherein the conformable sheet-form body is formed of a fabric material.

4. The mat of claim 1 wherein the conformable sheet-form body is formed of a heat-curable elastomeric material or a heat-curable thermoplastic material.

5. The mat of claim 1 wherein the conformable sheet-form body is formed of a top layer made of a fabric material and a bottom layer made of a heat-curable elastomeric material or a heat-curable thermoplastic material.

6. The mat of claim 1 wherein the plastically deformable member has a configuration that is sheet-like, is rod-like or is a flat strip.

7. The mat of claim 1 wherein the plastically deformable member is made of metal.

8. The mat of claim 1 wherein the plastically deformable member is a steel wire.

9. The mat of claim 9 wherein the steel wire has a carbon content of less than about 0.5%.

10. The mat of claim 9 wherein the steel wire is coated to match a color of a selected portion of the mat.

11. The mat of claim 1 wherein the plastically deformable member is secured to the edge of the conformable sheet-form body.

12. The mat of claim 1 wherein the plastically deformable member is embedded in the conformable sheet-form body.

13. A plastically deformable mat for conforming to the contour of an underlying contoured surface comprising:
a conformable sheet-form body formed of a top layer made of a fabric material and a bottom layer made of a heat-curable elastomeric material or a heat-curable thermoplastic material bounded by an edge and having a predetermined surface area to cover a specified portion of an underlying contoured surface; and
a steel wire having a carbon content of less than about 0.5% secured to the edge of the conformable sheet-form body.
